(19) United States
(12) Patent Application Publication
(10) Pub. No.: US 2024/0339772 A1
(43) Pub. Date: Oct. 10, 2024

(54) Connector and Connector Assembly

(71) Applicant: Tyco Electronics (Shanghai) Co., Ltd., Shanghai (CN)

(72) Inventors: Zhao Cheng, Shanghai (CN); Ming Shi, Shanghai (CN); Xiaozhi (George) Fu, Shanghai (CN); Dingbing (Frank) Fan, Shanghai (CN); Wei Zhang, Shanghai (CN)

(73) Assignee: Tyco Electronics (Shanghai) Co., Ltd., Shanghai (CN)

(21) Appl. No.: 18/627,542

(22) Filed: Apr. 5, 2024

(30) Foreign Application Priority Data
Apr. 7, 2023 (CN) 202320760626.7

(51) Int. Cl. H01R 12/70; H01R 12/77; H01R 13/436; H01R 13/506; H01R 43/20

(52) U.S. Cl. CPC H01R 12/7023; H01R 12/774; H01R 13/4361; H01R 13/506; H01R 43/205

(57) ABSTRACT

A connector comprises a first housing, a terminal arranged in the first housing, a second housing, and a locking member. The first housing includes a first slot adapted to receive the second housing. The terminal is adapted to electrically contact a circuit board received within a second slot of the second housing. A locking member is installed on the second housing and is adapted to lock the circuit board to the second housing. The second housing is movable relative to the first housing between a pre installation position where the terminal is adapted to be electrically separated from the circuit board and a final installation position wherein the terminal is adapted to be in electrical contact with the circuit board. The locking member is movable relative to the second housing between a pre locking position detached from the circuit board, and a final locking position engaged with the circuit board.

### CROSS-REFERENCE TO RELATED APPLICATION

This application claims the benefit of Chinese Patent Application No. CN 202320760626.7 filed on Apr. 7, 2023, in the State Intellectual Property Office of China, the whole disclosure of which is incorporated herein by reference.

### FIELD OF THE INVENTION

The present invention relates a connector and a connector assembly including the connector.

### BACKGROUND

In the prior art, a connector for a flexible printed circuit board (referred to as FPC) typically includes a first housing, a second housing, a locking member, and a terminal. The first housing is formed with a first slot for inserting the second housing. The second housing is formed with a second slot for inserting the FPC. The terminal is located in the second housing for electrical contact with the FPC. The locking member is installed on the second housing to lock the FPC to the second housing.

In the prior art, the first housing, second housing, and locking member of the connector cannot be pre-assembled together. Therefore, when assembling the connector, users need to first insert the FPC into the second housing, and then install the locking member onto the second housing to lock the FPC to the second housing. Finally, the second housing is inserted into the first housing. This leads to a more complex assembly process of the entire connector, reducing the assembly efficiency of the connector.

### SUMMARY

According to one embodiment of the present disclosure, a connector comprises a first housing, a terminal arranged in the first housing, a second housing, and a locking member. The first housing includes a first slot adapted to receive the second housing. The terminal is adapted to electrically contact a circuit board received within a second slot of the second housing. A locking member is installed on the second housing and is adapted to lock the circuit board to the second housing. The second housing is movable relative to the first housing between a pre installation position where the terminal is adapted to be electrically separated from the circuit board and a final installation position wherein the terminal is adapted to be in electrical contact with the circuit board. The locking member is movable relative to the second housing between a pre locking position detached from the circuit board, and a final locking position engaged with the circuit board.

### BRIEF DESCRIPTION OF THE DRAWINGS

The invention will now be described by way of example with reference to the accompanying Figures, of which:

FIG. 1 shows an illustrative perspective view of a connector assembly according to an exemplary embodiment of the present invention;

FIG. 2 shows an illustrative exploded view of a connector according to an exemplary embodiment of the present invention;

FIG. 3 shows an illustrative perspective view of the first housing of a connector according to an exemplary embodiment of the present invention;

FIG. 4 shows an illustrative perspective view of the second housing and locking member of a connector according to an exemplary embodiment of the present invention;

FIG. 5 shows an illustrative perspective view of a connector according to an exemplary embodiment of the present invention, wherein the first housing, second housing, and locking member are pre-assembled together;

FIG. 6 shows a horizontal sectional view of the connector shown in FIG. 5, where the first elastic buckle is engaged with the protrusion to lock the second housing in the pre installation position;

FIG. 7 shows a vertical sectional view of the connector shown in FIG. 5, where the locking member is in the pre locking position;

FIG. 8 shows an illustrative view of inserting the circuit board into the connector shown in FIG. 5, wherein the second housing and locking member are in the pre installation position and pre locked position, respectively;

FIG. 9 shows an illustrative assembly view of the second housing and circuit board according to an exemplary embodiment of the present invention;

FIG. 10 shows an illustrative exploded view of the second housing and circuit board according to an exemplary embodiment of the present invention;

FIG. 11 shows a cross-sectional view of the connector and circuit board shown in FIG. 8, wherein the second housing and locking member are in the pre installation position and pre locking position, respectively;

FIG. 12 shows an illustrative assembly view of a connector and a circuit board according to an exemplary embodiment of the present invention, wherein the second housing and locking member are in the final installation position and the final locking position, respectively; and

FIG. 13 shows a cross-sectional view of the connector and circuit board shown in FIG. 12, wherein the second housing and locking member are in the final installation position and the final locking position, respectively.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A connector according to an embodiment of the present disclosure comprises a first housing having a first slot; a terminal provided in the first housing for electrical contact with a circuit board, a second housing inserted into the first slot of the first housing and having a second slot for inserting the circuit board, and a locking member installed on the second housing and adapted to lock the circuit board to the second housing. The second housing is movable relative to the first housing between a pre installation position where the terminal is electrically separated from the circuit board and a final installation position where the terminal is in electrical contact with the circuit board; the locking member is movable relative to the second housing between a pre locking position detached from the circuit board and a final locking position engaged with the circuit board; before inserting the circuit board, the second housing and the locking member are respectively set at the pre installation position and the pre locking position.

According to another embodiment of the present disclosure, a connector assembly includes the above connector, and a circuit board inserted into the second housing of the connector. A conductive pad is formed on the circuit board and electrically contacts the terminal.

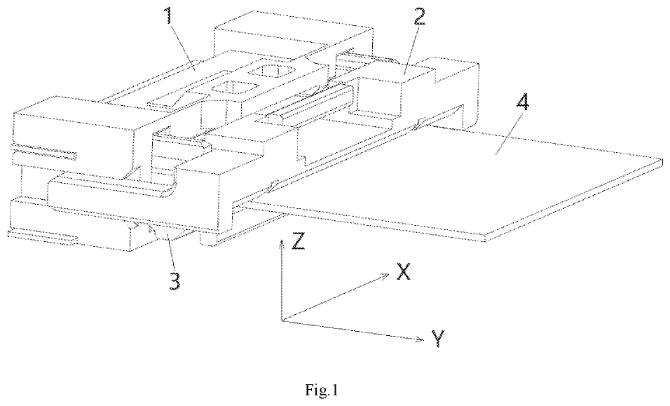

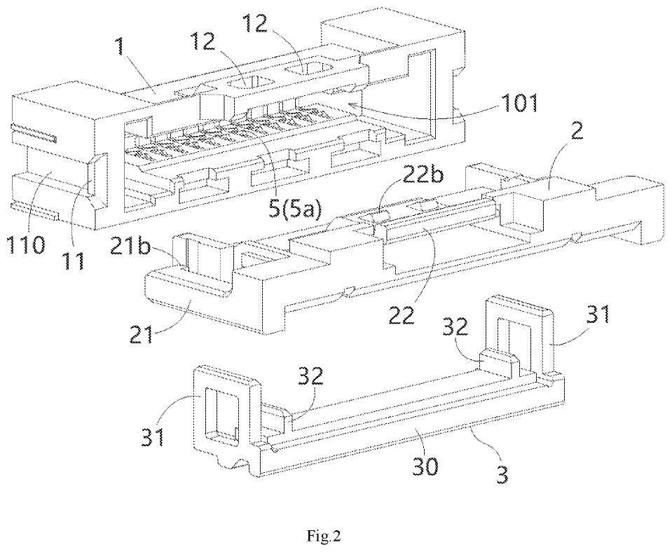

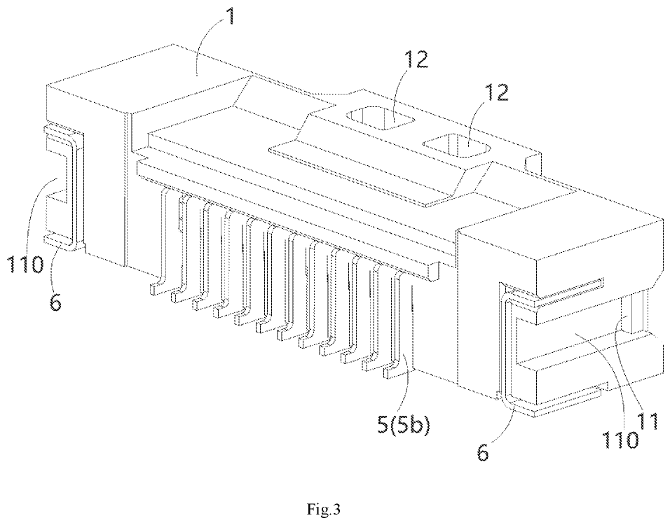

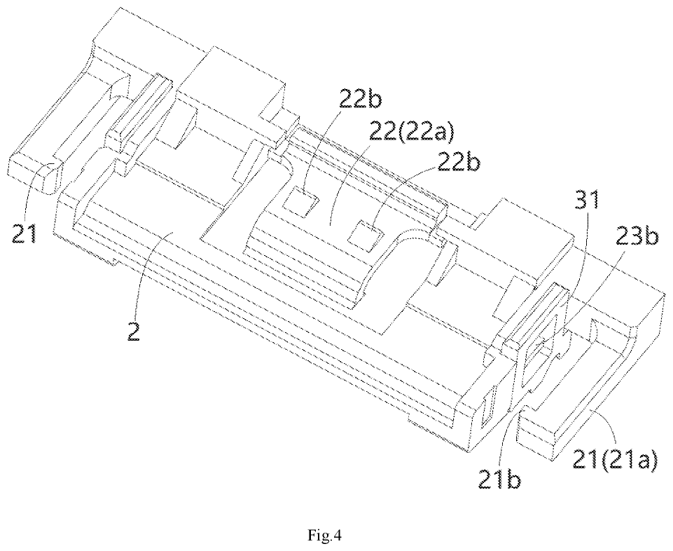

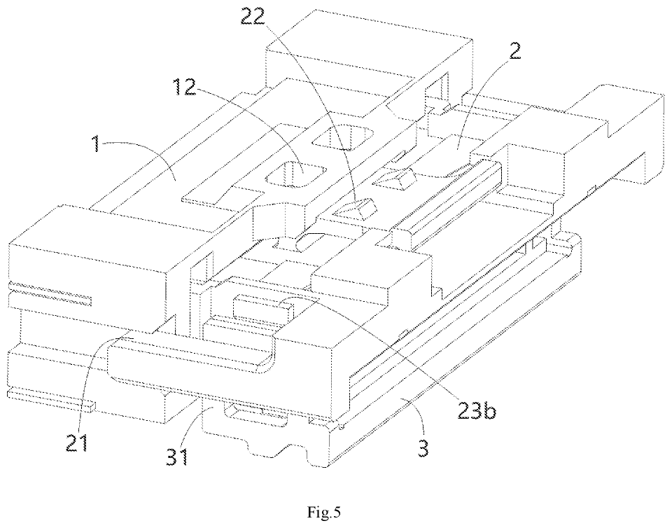

FIG. 1 is an illustrative perspective view of a connector assembly according to an exemplary embodiment of the present invention. FIG. 2 is an illustrative exploded view of a connector according to an exemplary embodiment of the present invention. FIG. 3 is an illustrative perspective view of the first housing of a connector according to an exemplary embodiment of the present invention. FIG. 4 is an illustrative perspective view of the second housing and locking member of a connector according to an exemplary embodiment of the present invention. FIG. 5 is an illustrative perspective view of a connector according to an exemplary embodiment of the present invention, wherein the first housing, second housing, and locking member are pre-assembled together.

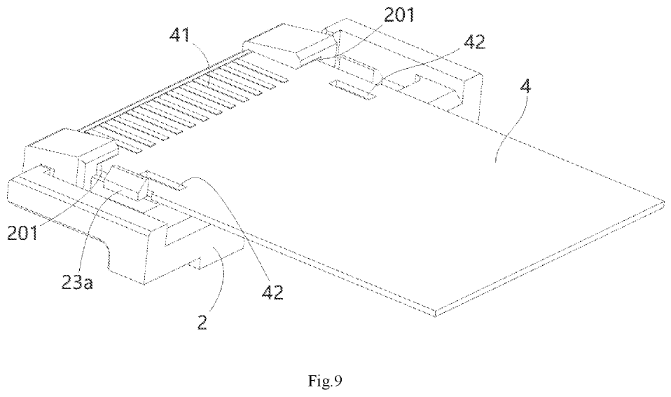

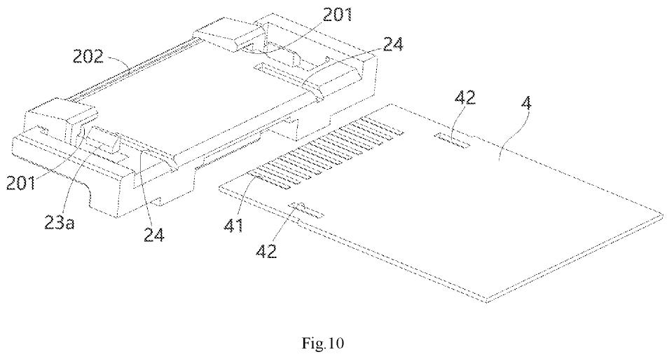

As shown in FIGS. 1-6, in an exemplary embodiment of the present disclosure, a connector is provided. The connector mainly includes a first housing 1, a second housing 2, a locking member 3, and a terminal 5. The first housing 1 has a first slot 101. The terminal 5 is located in the first housing 1 for electrical contact with a circuit board 4. The second housing 2 is inserted into the first slot 101 of the first housing 1 and has a second slot 201 for inserting the circuit board 4 (see FIGS. 9 and 10). The locking member 3 is installed on the second housing 2 to lock the circuit board 4 onto the second housing 2. In the illustrated embodiments, the aforementioned circuit board 4 can be a flexible printed circuit board (FPC).

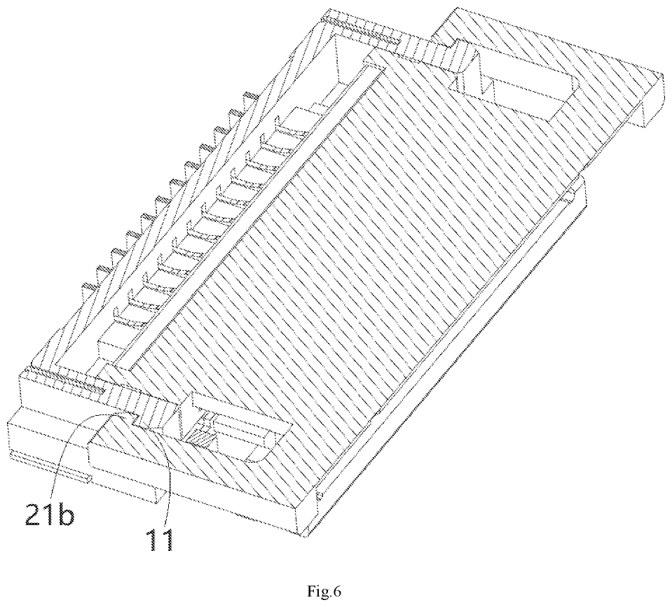

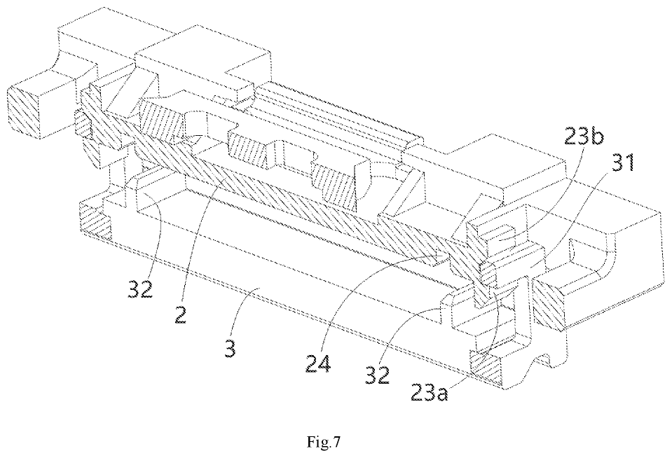

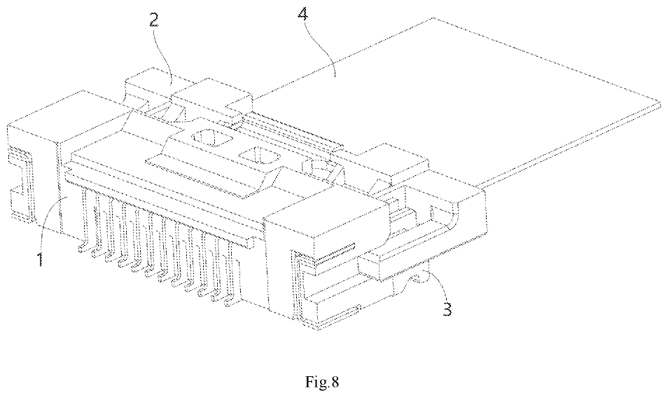

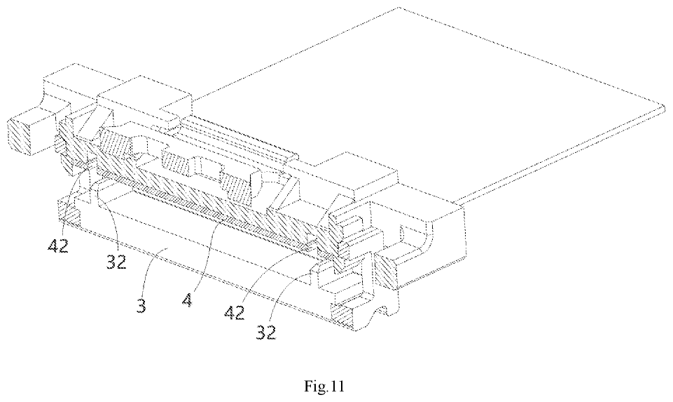

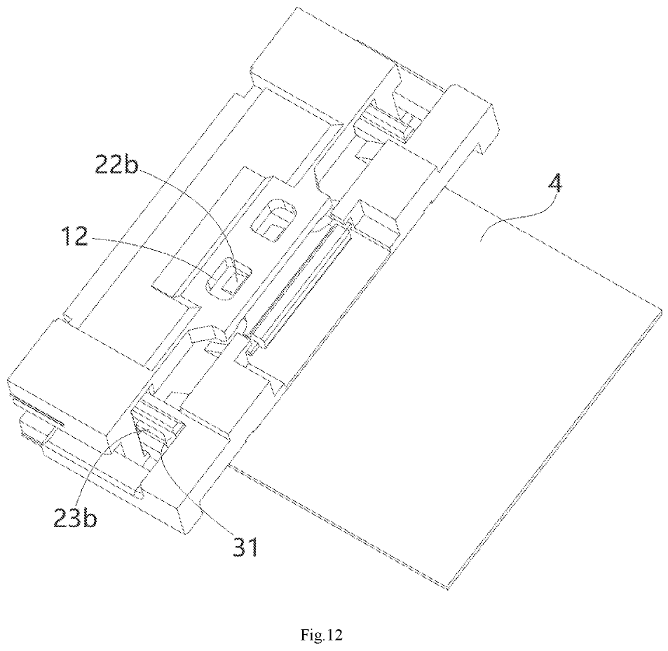

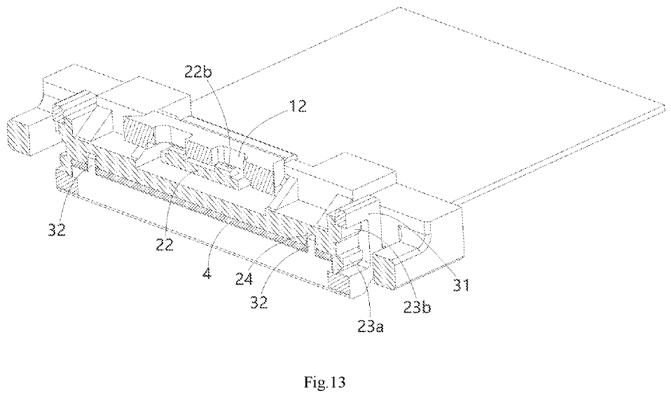

FIG. 6 is a horizontal sectional view of the connector shown in FIG. 5, wherein a first elastic buckle or latch 21 is engaged with a protrusion portion 11 to lock the second housing 2 in the pre installation position. FIG. 7 is a vertical sectional view of the connector shown in FIG. 5, wherein the locking member 3 is in the pre locking position. FIG. 8 is an illustrative view of inserting circuit board 4 into the connector shown in FIG. 5, wherein the second housing 2 and the locking member 3 are in the pre installation position and the pre locking position, respectively. FIG. 9 is an illustrative view of the assembly of the second housing 2 and the circuit board 4 according to an exemplary embodiment of the present invention. FIG. 10 is an illustrative exploded view of the second housing 2 and the circuit board 4 according to an exemplary embodiment of the present invention. FIG. 11 is a cross-sectional view of the connector and circuit board 4 shown in FIG. 8, wherein the second housing 2 and the locking member 3 are in the pre installation position and the pre locking position, respectively. FIG. 12 is an illustrative view of the assembly of a connector and circuit board 4 according to an exemplary embodiment of the present invention, wherein the second housing 2 and locking member 3 are in the final installation position and the final locking position, respectively. FIG. 13 is a cross-sectional view of the connector and circuit board 4 shown in FIG. 12, wherein the second housing 2 and locking member 3 are in the final installation position and final locking position, respectively.

As shown in FIGS. 1-13, in the illustrated embodiments, the second housing 2 can be moved relative to the first housing 1 between the pre installation position where the terminal 5 is electrically separated from circuit board 4 and the final installation position where the terminal 5 is electrically in contact with circuit board 4. The locking member 3 can be moved relative to the second housing 2 between the pre locking position that is detached from the circuit board 4 and the final locking position that is engaged with the circuit board 4. In the illustrated embodiment, before inserting the circuit board 4, the second housing 2 and the locking member 3 are respectively set in the pre installation position and the pre locking position. Therefore, in the present invention, before inserting the circuit board 4, the first housing 1, second housing 2, and locking member 3 can be pre-assembled together, which can reduce the steps for users to assemble the connector and improve the assembly efficiency.

The first housing 1 has a left wall and a right wall opposite to each other in its transverse direction X. Protrusions or protrusion portions 11 are formed on the left and right walls of the first housing 1, respectively. On the left and right sides of the second housing 2, first elastic latches or buckles 21 are respectively formed, which are used to engage with the protrusion portions 11 to lock the second housing 2 in the pre installation position. In the illustrated embodiments, the first elastic buckle 21 includes a first elastic arm 21a and a hook shaped portion 21b formed at the end of the first elastic arm 21a. The hook shaped portion 21b of the first elastic buckle 21 is adapted to engage with the protrusion portion 11 of the first housing 1 to lock the second housing 2 in the pre installation position.

The first housing 1 has a top wall and a bottom wall opposite to each other in its height direction Z, and a slot hole 12 is formed on the top wall of the first housing 1. A second elastic latch or buckle 22 is formed in the top of the second housing 2. The second buckle 22 is adapted to engage with the slot hole 12 to lock the second housing 2 in the final installation position. The second elastic buckle 22 includes a second elastic arm 22a and a protrusion 22b formed on the second elastic arm 22a. The protrusion 22b of the second elastic buckle 22 is adapted to engage with the slot hole 12 on the first housing 1 to lock the second housing 2 in the final installation position.

The second housing 2 has opposite left and right sides in its transverse direction X. Pre lock protrusions 23a are formed on the left and right sides of the second housing 2, respectively. The locking member 3 includes two third elastic latches or buckles 31 adapted to engage with the pre lock protrusions 23a on the left and right sides of the second housing 2, respectively. When the locking member 3 is in the pre locking position, the pre lock protrusion 23a on the second housing 2 engages with the third elastic buckle 31 to lock the locking member 3 in the pre locking position.

Final lock protrusions 23b are also formed on the left and right sides of the second housing 2, respectively. The pre lock protrusion 23a and the final lock protrusion 23b are spaced in the height direction Z of the second housing 2. When the locking member 3 is in the final locking position, the final locking protrusion 23b on the second housing 2 engages with the third elastic buckle 31 to lock the locking member 3 in the final locking position.

The locking member 3 includes a body portion 30 that extends along the transverse direction X of the second housing 2. Two third elastic buckles 31 are formed at the left and right ends of the body portion 30, respectively. A tongue portion 32 is formed on the top surface of the body portion 30 of the locking member 3, which is used to insert into the insertion hole 42 in the circuit board 4 to lock the circuit board 4 to the second housing 2. When the locking member 3 is in the pre locking position and the circuit board 4 has been inserted into the second housing 2, the tongue portion 32 on the locking member 3 is not inserted into the insertion hole 42 of the circuit board 4. When the locking member 3 is in the final locking position and the circuit board 4 has been inserted into the second housing 2, the tongue portion 32 on locking member 3 is inserted into the insertion hole 42 of circuit board 4.

The second slot 201 is formed on the bottom of the second housing 2. The locking member 3 is installed on the bottom of the second housing 2. A positioning slot 24 corresponding to the tongue portion 32 on the locking member 3 is formed on the bottom of the second housing 2. When the locking member 3 is in the final locking position and the circuit board 4 has been inserted into the second housing 2, the tongue portion 32 on locking member 3 passes through the insertion hole 42 of the circuit board 4 and is inserted into the positioning slot 24 of the second housing 2.

In another exemplary embodiment of the present invention, a connector assembly is also disclosed. The connector assembly includes the aforementioned connector and the circuit board 4, which is inserted into the second housing 2 of the connector. A conductive pad 41 is formed on the circuit board 4. The conductive pad 41 is adapted to electrically contact the terminal 5 in the connector. An insertion hole 42 is formed in the circuit board 4 for engaging with the tongue portion 32 on the locking member 3.

A row of the terminals 5 is provided in the first housing 1 of the connector. Each terminal 5 has an elastic contact portion 5a located in the first slot 101 of the first housing 1. A row of conductive pads 41 is formed on the circuit board 4. The conductive pads 41 are exposed from the second housing 2 and are in electrical contact with the elastic contact portions 5a of the row of terminals 5.

The first slot 101 has an opening and a bottom wall opposite to each other in the longitudinal direction Y of the first housing 1. The terminal 5 has a welding part 5b exposed from the bottom wall of the first slot 101. The connector also includes a metal fixing member 6 fixed to the first housing 1. The metal fixing member 6 and the welding part 5b of the terminal 5 are adapted to be welded or soldered to the circuit board (not shown). For example, it can be soldered to the circuit board by surface mounting.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a first housing having a first slot;
a terminal arranged in the first housing and adapted to electrically contact a circuit board;
a second housing insertable into the first slot of the first housing and having a second slot adapted to receive the circuit board; and
a locking member installed on the second housing and adapted to lock the circuit board to the second housing, wherein:
the second housing is movable relative to the first housing between a pre installation position wherein the terminal is adapted to be electrically separated from the circuit board, and a final installation position wherein the terminal is adapted to be in electrical contact with the circuit board; and
the locking member is movable relative to the second housing between a pre locking position detached from the circuit board, and a final locking position engaged with the circuit board.

2. The connector according to claim 1, wherein the first housing has left and right walls opposite to each other in its transverse direction.

3. The connector according to claim 2, wherein protrusions are formed on the left and right walls of the first housing respectively, and first elastic latches are formed on the left and right sides of the second housing and engage with the protrusions to lock the second housing in the pre installation position.

4. The connector according to claim 3, wherein each of the first elastic latches includes a first elastic arm and a hook shaped portion formed at the end of the first elastic arm, the hook shaped portion of the first elastic latch is adapted to engage with the protrusion of the first housing to lock the second housing in the pre installation position.

5. The connector according to claim 1, wherein:
the first housing has opposite top and bottom walls in its height direction, and a slot hole is formed in the top wall of the first housing; and
a second elastic latch is formed at a top of the second housing and is adapted to engage with the slot hole to lock the second housing in the final installation position.

6. The connector according to claim 5, wherein the second elastic latch includes a second elastic arm and a protrusion formed on the second elastic arm, the protrusion of the second elastic latch engages with the slot hole on the first housing to lock the second housing in the final installation position.

7. The connector according to claim 1, wherein the second housing has opposite left and right sides in its transverse direction, and pre lock protrusions are formed on the left and right sides of the second housing, respectively.

8. The connector according to claim 7, wherein:
the locking member includes two third elastic latches adapted for engagement with the pre lock protrusions on the left and right sides of the second housing, respectively; and
when the locking member is in the pre locking position, the pre lock protrusion on the second housing engages with the third elastic latch to lock the locking member in the pre locking position.

9. The connector according to claim 8, wherein:
final locking protrusions are formed on each of the left and right sides of the second housing, the pre lock protrusion and the final lock protrusion are separated in the height direction of the second housing;
when the locking member is in the final locking position, the final locking protrusion on the second housing engages with the third elastic latch to lock the locking member in the final locking position.

10. The connector according to claim 9, wherein the locking member comprises a body portion that extends along a transverse direction of the second housing, the two third elastic latches are formed at the left and right ends of the body portion, respectively.

11. The connector according to claim 10, wherein a tongue portion is formed on a top surface of the body portion of the locking member and is adapted to be inserted into an insertion hole in the circuit board to lock the circuit board to the second housing.

12. The connector according to claim 11, wherein:
when the locking member is in the pre locking position and the circuit board has been inserted into the second housing, the tongue portion on the locking member is not inserted into the insertion hole of the circuit board; and
when the locking member is in the final locking position and the circuit board has been inserted into the second housing, the tongue portion on the locking member is inserted into the insertion hole of the circuit board.

13. The connector according to claim 12, wherein the second slot is formed on the bottom of the second housing, and the locking member is installed on the bottom of the second housing.

14. The connector according to claim 13, wherein:
a positioning slot corresponding to the tongue portion on the locking member is formed on the bottom of the second housing; and
when the locking member is in the final locking position and the circuit board has been inserted into the second housing, the tongue portion on the locking member passes through the insertion hole of the circuit board and is inserted into the positioning slot of the second housing.

15. A connector assembly, comprising:
a connector, including:
a first housing having a first slot;
a terminal arranged in the first housing and adapted to electrically contact a circuit board;
a second housing insertable into the first slot of the first housing and having a second slot; and
a locking member installed on the second housing; and
a circuit board inserted into the second slot of the second housing, the locking member adapted to lock the circuit board to the second housing, the circuit board includes a conductive pad electrically contacting the terminal, wherein:
the second housing is movable relative to the first housing between a pre installation position wherein the terminal is adapted to be electrically separated from the circuit board and a final installation position wherein the terminal is adapted to be in electrical contact with the circuit board; and
the locking member is movable relative to the second housing between a pre locking position detached from the circuit board and a final locking position engaged with the circuit board.

16. The connector assembly according to claim 15, wherein an insertion hole is formed in the circuit board and adapted to engage with the tongue portion on the locking member.

17. The connector assembly according to claim 15, wherein:
a row of terminals is provided in the first housing of the connector, and the terminal has an elastic contact portion located in the first slot of the first housing; and
a row of conductive pads is formed on the circuit board, the row of conductive pads is exposed outside the second housing and are in electrical contact with the elastic contact portions of the row of terminals.

18. The connector assembly according to claim 17, wherein the first slot has an opening and a bottom wall opposite to each other in a longitudinal direction of the first housing, and the terminal has a welding part exposed from the bottom wall of the first slot.

19. The connector assembly according to claim 18, wherein the connector further comprises a metal fixing member fixed to the first housing, the metal fixing member and the welding part of the terminal are welded to the circuit board.

20. The connector assembly according to claim 15, wherein the circuit board is a flexible printed circuit board.
